(19) United States
(12) Patent Application Publication
(10) Pub. No.: US 2012/0081079 A1
(43) Pub. Date: Apr. 5, 2012

(54) EMERGENCY DISCHARGE FEATURE

(75) Inventors: RICHARD J. BURNS, Bolton, MA (US); DAVID W. TROUNSON, Wayland, MA (US); RYLAN IAN GRANT, Carlisle, MA (US); NAIM MARK KAHWATI, Littleton, MA (US)

(73) Assignee: Teradyne, Inc.

(21) Appl. No.: 12/898,150

(22) Filed: Oct. 5, 2010

(51) Int. Cl. H02J 7/00

(52) U.S. Cl. 320/136

(57) ABSTRACT

A system includes a channel over which to charge a battery, control circuitry, and a discharge circuit associated with the channel to discharge the battery. The discharge circuit is configured for discharging the battery at a current that exceeds an operational current through the channel. In response to a fault in the battery, the control circuitry is configured to disconnect the battery from a signal path in the channel and to produce an electrical connection to enable discharge of the battery through the discharge circuit.

### TECHNICAL FIELD

This patent application relates generally to discharging a battery, e.g., in response to a fault detected in the battery.

### BACKGROUND

Battery formation, which can include testing, involves charging and discharging batteries. Faults can occur during the testing and formation process. For example a latent defect in a battery, such as a micro-short circuit, can cause rapid self-discharge within the battery. During this rapid self-discharge, a relatively large amount of power is discharged inside the battery. This can cause battery self-heating, melting, and a larger short circuit within the battery. These conditions are precursors to thermal runaway, which can result in combustion of the battery's electrolyte. Sometimes, this combustion can be explosive.

Battery combustion, particularly explosive combustion, can harm other batteries in a test system and the test system itself. More specifically, such systems can pack batteries at high densities. Combustion in one battery can propagate to other batteries, thereby causing a chain reaction in the system. This can lead to fire, which can result in personal and property damage.

### SUMMARY

This patent application describes techniques for discharging a battery, e.g., in response to a fault detected in the battery.

Described herein is a system that includes a channel over which to charge a battery, control circuitry, and a discharge circuit associated with the channel to discharge the battery. The discharge circuit is configured for discharging the battery at a current that exceeds an operational current through the channel. In response to a fault in the battery, the control circuitry is configured to disconnect the battery from a signal path in the channel and to produce an electrical connection to enable discharge of the battery through the discharge circuit. The system may include one or more of the features described herein either alone or in combination, examples of which are as follows.

The control circuitry may comprise a first switch configured to connect/disconnect the battery to/from a test/charging path in the channel, a second switch configured to connect/disconnect the battery to a discharge path, and a controller to control the first switch and the second switch. The control circuitry may comprise regulator circuitry to regulate current through the battery during discharge so that current through the discharge circuit is substantially constant during at least a portion of the time that the battery is discharging. The control circuitry may comprise a controller. The controller may be configured to disconnect, from corresponding channels, batteries that are within a predefined area relative to the battery having the fault, thereby inhibiting further charging of the batteries. The controller may be configured to initiate discharge of batteries that are within a predefined area relative to the battery having the fault. The batteries within the predefined area may comprise batteries that are directly adjacent to the battery having the fault. The fault may comprise thermal runaway in the battery.

Also described herein is a system comprising a discharge element to discharge a battery and control circuitry to control discharge of the battery in response to detection of a fault in the battery in order to maintain a substantially constant current through the discharge element during at least part of a period of time during which the battery discharges. The system may include one or more of the features described herein either alone or in combination, examples of which are as follows.

The control circuitry may comprise a current control device in a circuit path between the discharge element and the battery, a detector to detect a voltage across the discharge element and thereby output a detected voltage, and a regulator circuit to regulate a control signal to the current control device in accordance with the detected voltage. The regulator circuit may comprise a voltage source to produce a reference voltage, a comparison circuit to compare the reference voltage to the detected voltage and thereby output an error voltage, and a controller to regulate the control signal based on the error voltage. The current control device may comprises a field-effect transistor. The system may include leakage isolation circuitry to control transistor leakage in the control circuitry. The detector may comprise a first differential amplifier and the comparison circuit may comprise a second differential amplifier.

Also described herein is a system comprising a channel over which to charge a battery, controlling means, and discharging means associated with the channel for discharging the battery. The discharging means is for discharging the battery at a current that exceeds an operational current through the channel. In response to a fault in the battery, the controlling means disconnects the battery from the channel and produces an electrical connection to enable discharge of the battery through the discharge circuit. The system may include one or more of the features described herein either alone or in combination.

Also described herein is a method of discharging a battery, which comprises detecting a fault in a battery during test or formation of the battery, and discharging the battery in response to the fault. The discharging may be performed at a current that exceeds an operational current through a communication channel over which test or formation occurs. The method may include one or more of the features described herein either alone or in combination, examples of which are as follows.

Test or formation may comprise sending signals to the battery over a channel. The method may further comprise disconnecting the battery from a signal path in the channel in response to the fault, and establishing an electrical connection to enable discharge of the battery through a discharge circuit. Discharging may occur while maintaining a substantially constant current through the battery. The method may further comprise controlling a current control device to maintain the substantially constant current. Discharging may occur through an impedance circuit that is electrically connected in a current path with the battery in response to detecting the fault.

At least part of any of the foregoing may be implemented as an apparatus, method, or system that may include circuitry and/or one or more processing devices and memory to store executable instructions to implement the stated functions.

At least part of any of the foregoing may be implemented as a computer program product comprised of instructions that are stored on one or more non-transitory machine-readable storage media, and that are executable on one or more processing devices.

The details of one or more implementations are set forth in the accompanying drawings and the description below. Other features, objects, and advantages will be apparent from the description and drawings, and from the claims.

### DESCRIPTION OF THE DRAWINGS

FIGS. 1 to 3 are circuit diagrams showing circuitry for discharging a battery.

FIGS. 4, 6 and 7 are circuit diagrams showing an alternative implementation of circuitry for discharging a battery.

FIG. 5 is a circuit diagram showing details of an integrator circuit found in FIG. 4.

FIG. 8 is a circuit diagram showing an alternative implementation of the circuitry of FIG. 4.

FIG. 9 is a circuit diagram showing leakage isolation circuitry that may be used in place of any switch or transistor described herein.

FIG. 10 is a circuit diagram showing an alternative implementation of circuitry for discharging a battery.

### DETAILED DESCRIPTION

Described herein is circuitry that may be used in a system for forming and testing batteries, including lithium-ion batteries having a lithium-cobalt-oxide chemistry. The circuitry described herein is not limited to use with lithium-ion batteries and may be used in connection with any type of battery.

In an example, the circuitry includes a controller, a channel over which to charge a battery, and a discharge circuit associated with the channel to discharge the battery. In response to detection of a fault in the battery (e.g., thermal runaway or conditions leading thereto), the controller disconnects the battery from the channel and establishes an electrical connection that enables discharge of the battery through the discharge circuit.

The discharge circuit described herein uses a relatively low impedance—close to a controlled short circuit path—which enables an increased discharge rate. In this regard, the discharge circuit operates at a higher current (sometimes, a significantly higher current) than the current at which its associated test channel is capable of operating during normal operation (e.g., formation and test). For example, the channel operating current might be 20 A, whereas the discharge circuit might be 160 A. Consequently, it may take an hour or more to fully discharge a battery using known techniques, whereas the discharge circuit descried herein is configured to remove stored energy from the battery more rapidly, e.g., before the battery has a chance to self-destruct.

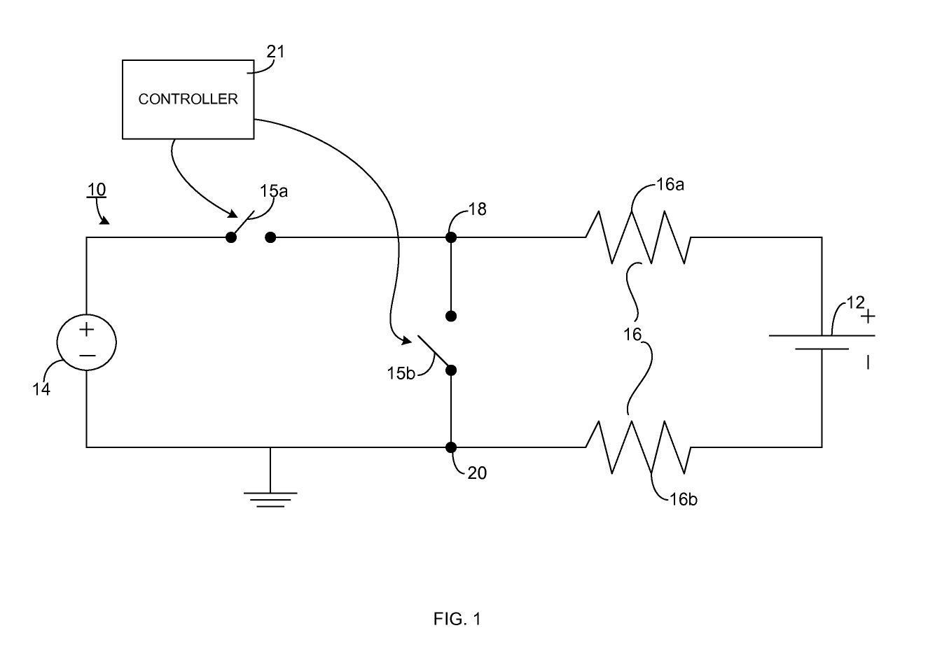

FIG. 1 shows an example of the foregoing circuitry. More specifically, FIG. 1 shows a channel 10 with a connection to battery 12. Channel 10 may be a test channel that is part of a battery formation and test system, such as that described in U.S. Provisional Application No. 61/359,597, entitled “TEST SYSTEM” (Attorney Docket No. 18523-100P01/2236-US), the contents of which are incorporated by reference into this patent application as if set forth herein in full. Hereafter, the battery formation and test system is referred to simply as a battery test system.

In FIG. 1, channel 10 includes a voltage source 14, switches 15a and 15b, and an impedance circuit 16. Switch 15a is controllable to close or to open. When closed, switch 15a connects voltage source 14 to battery 12 and, when opened, switch 15a disconnects voltage source 14 from battery 12. Switch 15b is also controllable to open and to close. When closed, switch 15b short-circuits channel 10, e.g., by connecting points 18 and 20 of channel 10. When open, switch 15b disconnects points 18 and 20.

Switches 15a and 15b may be implemented using any appropriate circuitry. For example, relays, field-effect transistors and/or bipolar junction transistors may be used to implement the switches. The switches may include additional circuitry as well.

Impedance circuit 16 acts as a discharge element for battery 12 in that current output from battery 12 passes through the impedance circuit, thereby discharging the battery. Impedance circuit 16 may include resistors 16a and 16b, which may include parasitic element(s). Resistors 16a and 16b may be located on either side of battery 12, as shown in FIG. 1. In other examples, impedance circuit 16 may include another, or additional, circuit element(s). Such circuit elements may be positioned in any appropriate relationship to channel 10 and battery 12 that will enable battery discharge in the manner described herein. In this example, resistors 16a and 16b have a relatively low impedance, which allows the discharge to take place at an elevated rate, and at a higher current than the current at which the test channel normally operates. Resistances may include the contact connection to the battery (cell) itself, the wires connecting the channel and cell, and/or the discharge switch itself. Other resistances may include traces on a printed circuit card assembly used to implement the channel. The resistance may include a physical resistor in series with the other resistive elements for the purpose of ensuring a controlled discharge current. A physical resistor is not necessary for the operation of the circuit. Examples of a relatively low impedance are a round trip path resistance on the order of 15 milliOhm or a range of 5 to 50 milliOhm, although the circuitry described herein is not limited to use with these relatively low resistance values.

In this example, controller 21 is not part of channel 10, but rather is a central controller for the battery test system (of which channel 10 is a part). Alternatively, the controller may be part of the channel. Controller 21 controls operation of switches 15a and 15b. The operation of switches 15a and 15b may be controlled in response to detection of a fault in battery 12. For example, controller 21 may control operation of switches 15a and 15b in response to a fault (e.g., a failure signature) detected in accordance with any technique described in U.S. patent application Ser. No. 12/825,941, entitled “ELECTRONIC DETECTION OF FAILURE SIGNATURES”, the contents of which are incorporated by reference into this patent application as if set forth herein in full. It is noted, however, that the circuitry described herein for discharging a battery may be used in connection with any type of system for detecting fault(s) in a battery under formation and/or test, or with any type of system that requires battery discharge.

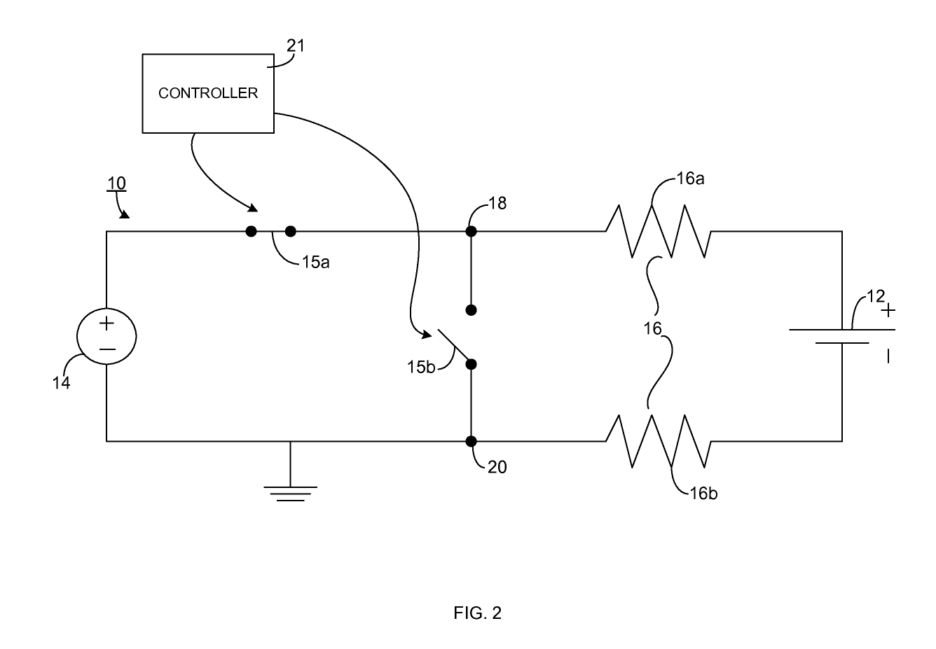

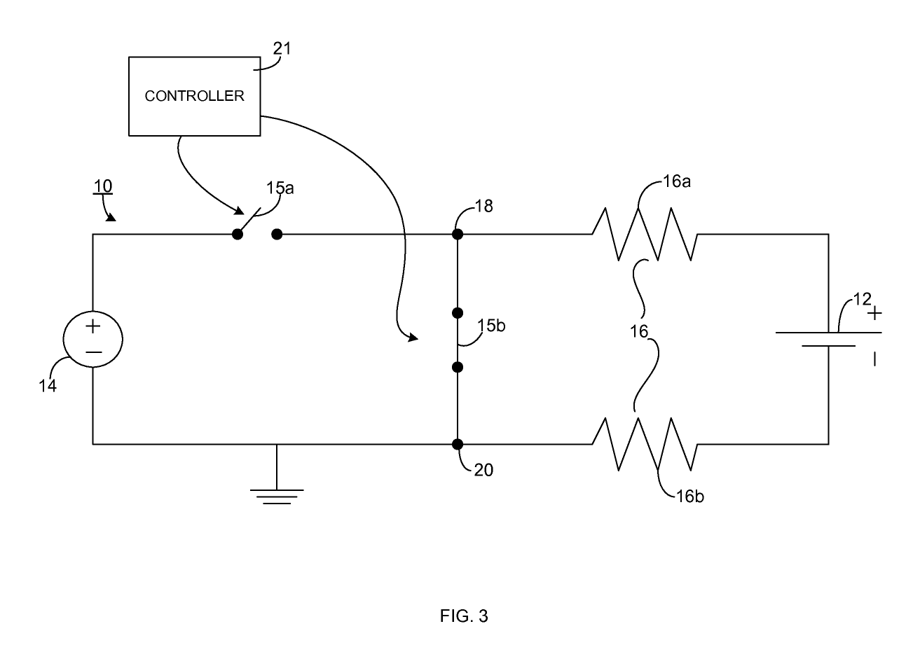

During normal operation, e.g., formation and test, controller 21 closes switch 15a and opens switch 15b. In this configuration (FIG. 2), voltage source 14 is connected to battery 12, thereby allowing current to charge battery 12. Testing may also be performed in this configuration. In response to a detected fault in battery 12, controller 21 closes switch 15b and opens switch 15a (FIG. 3). In this configuration, voltage source 14 is disconnected from battery 12 and channel 10 is short circuited (e.g., points 18 and 10 of channel 10 are connected electrically). In this configuration, battery 12 discharges through resistors 16a and 16b. Discharge may occur until battery 12 is depleted or substantially depleted. The battery may then be removed from the system relatively safely. This may occur after full, or partial, discharge.

In the case of lithium-ion batteries, discharge typically occurs until the battery is fully depleted or depleted at least to a point where it can be removed from the system safely. However, controller 21 may be programmed to control switches 15a and 15b so that they discharge battery 12 to a predefined voltage, whereafter controller 21 may control switches 15a and 15b to re-connect voltage source 14 to battery 12 and thereby proceed with charge and/or test. That is, switches 15a and 15b may be placed in the configuration of FIG. 3 for battery discharge until the voltage across battery 12 reaches a predefined voltage. Thereafter, switches 15a and 15b may be placed in the configuration of FIG. 2 for subsequent charge and/or test. In this example, circuitry (not shown) may be used to measure the voltage across battery 12, and to report that voltage back to controller 21 which, in turn, controls the switches based on the voltage.

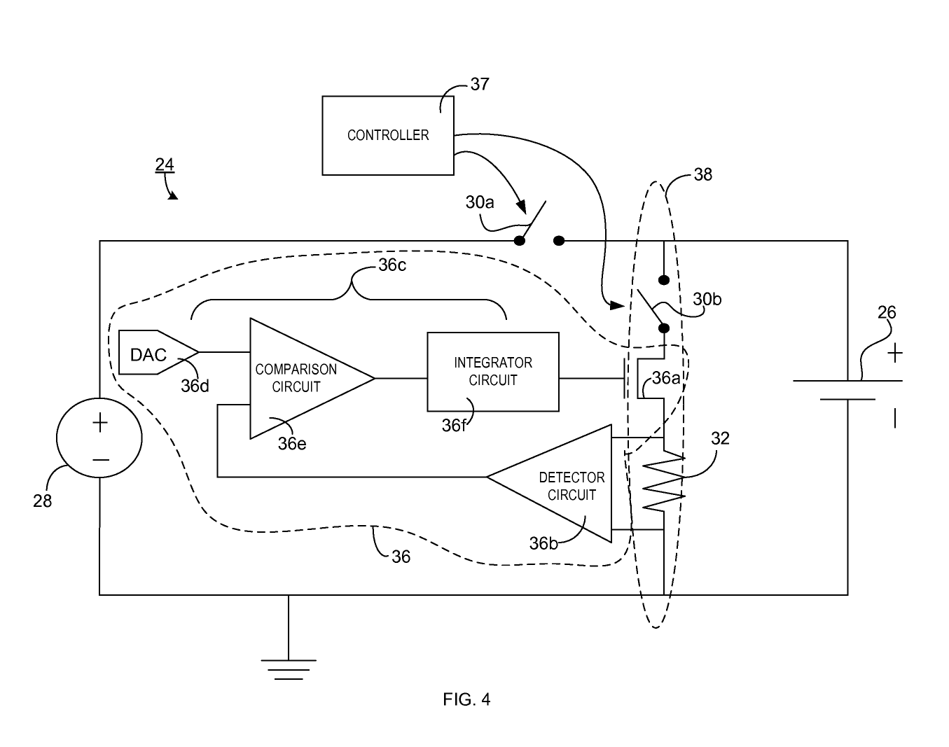

FIG. 4 shows an alternative implementation of circuitry for discharging a battery. This circuitry uses a current sink and maintains a substantially constant current during discharge. This substantially constant current is a higher current (sometimes a significantly higher current) than the current at which its associated test channel is capable of operating during normal operation (e.g., formation and test).

As above, FIG. 4 shows an example of a channel 24 with a connection to battery 26. As was also the case above, the channel may be part of a battery system, such as that described in U.S. Provisional Application No. 61/359,597, entitled “TEST SYSTEM” (Attorney Docket No. 18523-100P01/2236-US). Battery 26 may be a lithium-ion battery; however, the circuitry described herein is not limited to use with lithium-ion batteries and may be used in connection with any type of battery.

In FIG. 4, channel 24 includes a voltage source 28, switches 30a and 30b, impedance circuit 32, and control circuitry 36. Control circuitry 36 is configured to control discharge of the battery and, while doing so, maintaining a substantially constant current through the impedance circuit during at least part of the discharge period.

Switches 30a and 30b operate in a way that is substantially similar to the way that switches 15a and 15b of FIG. 1 operate. More specifically, switch 30a is controllable to close or to open. When closed, switch 30a connects voltage source 28 to battery 26 and, when opened, switch 30a disconnects voltage source 28 from battery 26. Switch 30b is also controllable to open and to close. When closed, switch 30b connects circuit path 38 containing a discharge element (impedance circuit 32) and control circuitry 36 to battery 26 and, when opened, switch 30b disconnects circuit path 38 from battery 26.

As was the case for FIG. 1, switches 30a and 30b may be implemented using any appropriate circuitry. For example, relays, field-effect transistors and/or bipolar junction transistors may be used to implement the switches. The switches may include additional circuitry as well.

In this example, controller 37 is not part of channel 24, but rather is a central controller for the battery test system (of which channel 24 is a part). Alternatively, the controller may be part of the channel. Controller 37 controls operation of switches 30a and 30b. The operation of switches 30a and 30b may be controlled in response to detection of a fault in battery 26. For example, controller 37 may control operation of switches 30a and 30b in response to a fault (e.g., a failure signature) detected in accordance with any technique described in U.S. patent application Ser. No. 12/825,941, entitled “ELECTRONIC DETECTION OF FAILURE SIGNATURES”. It is noted, however, that the circuitry described herein for discharging a battery may be used in connection with any type of system for detecting fault(s) in a battery under formation and/or test, or with any type of system that requires battery discharge.

Impedance circuit 32 acts as a discharge element for battery 26 in that current output from battery 26 passes through impedance circuit 32, thereby discharging the battery. Impedance circuit 32 may include one or more resistor(s) (only one is shown). In other examples, impedance circuit 32 may include other, or additional, circuit elements. Such circuit elements may be positioned in any appropriate relationship to channel 24 and battery 26 that will enable battery discharge in the manner described herein.

As noted above, control circuitry 36 is configured to control discharge of the battery so as to maintain a substantially constant current through impedance circuit 32 during at least part of a period of time when the battery discharges. To this end, control circuitry 36 includes a current control device 36a in a circuit path between the impedance circuit 32 and battery 26; a detector circuit 36b to detect a voltage across impedance circuit 32 and thereby output a detected voltage; and circuitry 36c to regulate a control signal to current control device 36a in accordance with the detected voltage.

Current control device 36a may be a transistor, such as a field effect transistor (FET), although a bipolar junction transistor (BJT) or any other appropriate switching circuit or electromechanical switch may be used. Detector circuit 36b may be a differential amplifier that detects a voltage difference across impedance circuit 32. Regulator circuitry 36c may include a reference voltage source 36d to produce a reference voltage; a comparison circuit 36e to compare the reference voltage to the voltage detected by detector circuit 36b and thereby output an error voltage; and an integrator circuit 36f to regulate the control signal applied to current control device 36a based on the error voltage output by comparison circuit 36e. For example, integrator circuit 36f may regulate the voltage applied to the gate of a current control FET implementing the current control device.

Reference voltage source 36d may include a digital-to-analog converter (DAC) that is programmable to output a reference analog voltage. Comparison circuit 36f may be a differential amplifier that is configured to compare the voltage detected across impedance circuit 32 with the reference voltage from the DAC. The reference voltage may be set so that the voltage difference detected by the differential amplifier 36e, i.e., the voltage difference between the reference voltage and the voltage across impedance circuit 32, is zero when an appropriate current passes through the impedance circuit. When that difference deviates from zero, comparison circuit 36e outputs a non-zero error signal to integrator circuit 36f. For example, if comparison circuit 36e is a differential amplifier, the output of the differential amplifier will be non-zero if the difference between the reference voltage and the voltage across impedance circuit 32 is non-zero.

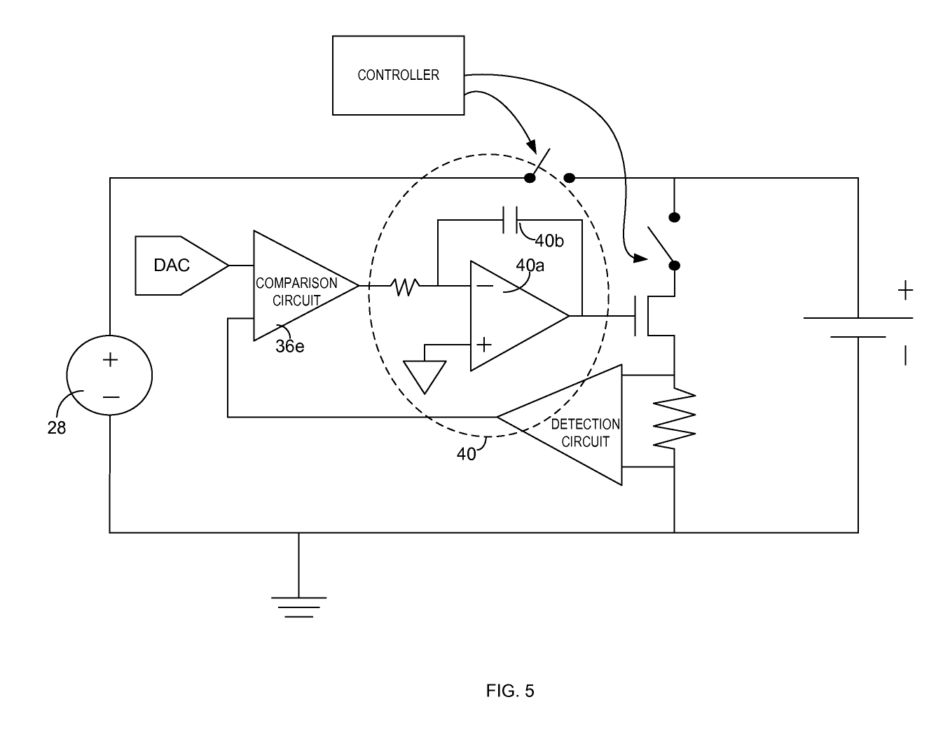

In this example, if the error signal output by comparison circuit 36e remains zero (or, in other examples, some other constant voltage), integrator circuit 36f outputs a voltage that is substantially constant. This is because, e.g., the integration of zero is a constant. If the error signal deviates from zero, then the voltage output of integrator circuit 36f is altered to regulate the current through impedance circuit 32 until that current reaches a value that produces a voltage across impedance circuit 32 that is substantially the same as the reference voltage. FIG. 5 shows an example of circuitry 40 that may be used to implement integrator circuit 36f. Circuitry 40 includes an amplifier 40a having its non-inverting input connected to ground and its inverting input connected to the output of comparison circuit 36e and to a feedback capacitor 40b. Resistors may also be incorporated into the circuitry, as shown in FIG. 5. Another example of circuitry that may be used to implement integrator circuit 36f is a Proportional-Integral-Derivative (PID) controller.

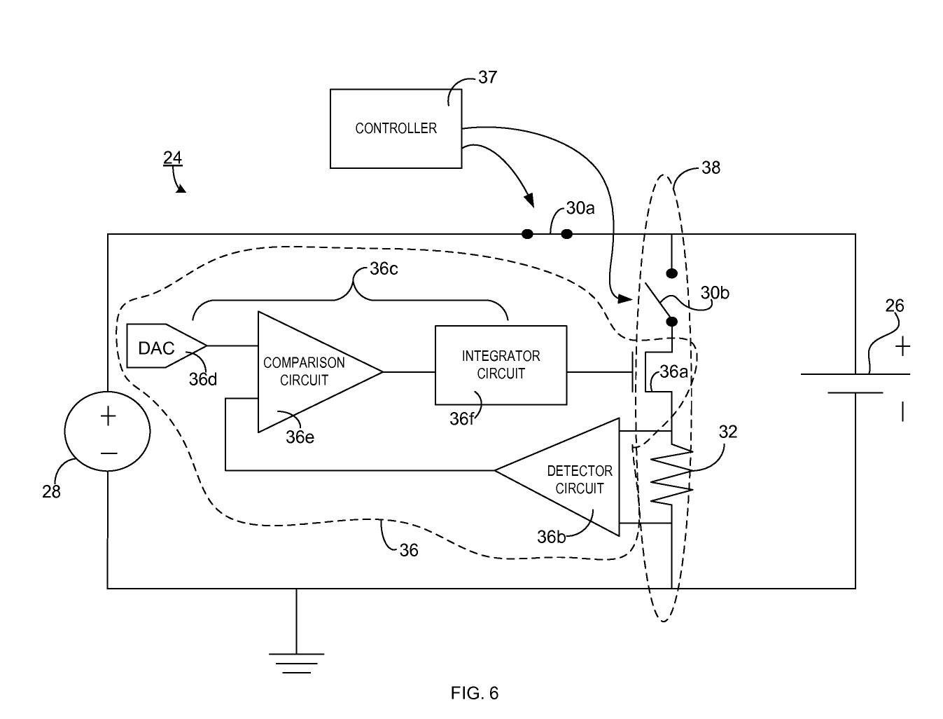

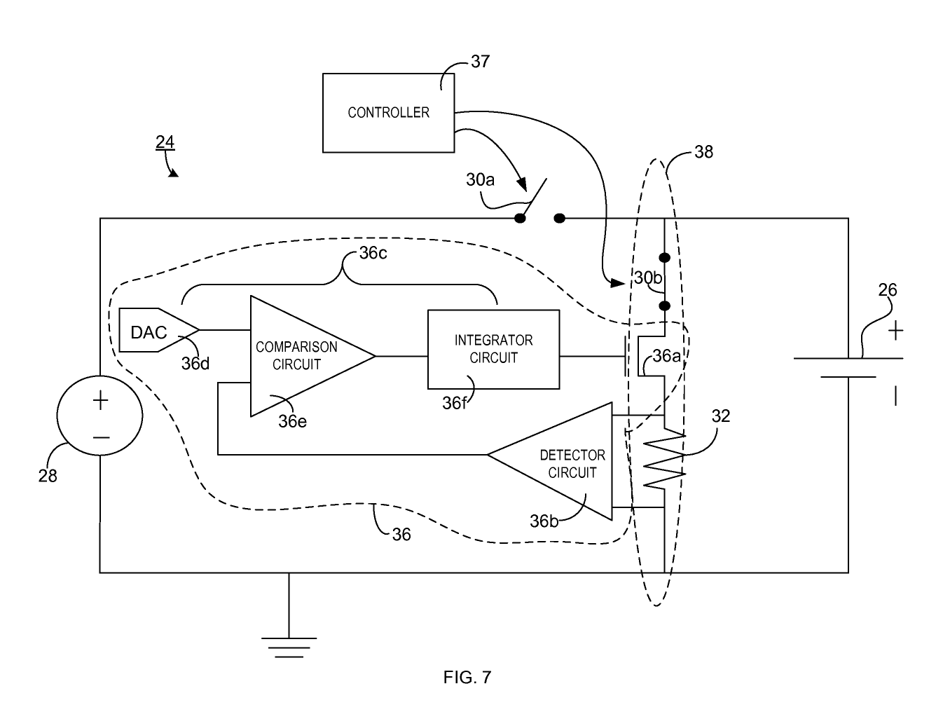

During normal operation, e.g., formation and test, controller 37 closes switch 30a and opens switch 30b. In this configuration (FIG. 6), voltage source 28 is connected to battery 26, thereby allowing current to charge battery 26. Testing may also be performed in this configuration. In response to a detected fault in battery 26, controller 37 closes switch 30b and opens switch 30a (FIG. 7). In this configuration, battery 26 is disconnected from voltage source 26 and battery 26 is connected to circuit path 38 containing current control device 36a and impedance circuit 32. Battery 26 therefore discharges through circuit path 38. This discharge is controlled, however, so that current through impedance circuit 32 remains substantially constant during a period of time. In an example, this period of time may be until the battery is no longer able to sustain that current or until it is safe to remove the battery from the test system.

More specifically, in operation, detector circuit 36b detects the voltage across impedance circuit 32, and outputs that voltage to comparison circuit 36e. Comparison circuit 36e determines a difference between that detected voltage and the reference voltage output by voltage source 36d. The resulting difference constitutes an error signal. If the error signal has a value of zero or substantially zero (i.e., the detected voltage and the reference voltage are substantially the same), then integrator circuit 36f outputs a constant control signal (e.g., voltage) to current control device 36a. For example, in this case, integrator circuit 36f may start/continue application of a constant voltage to the gate of a FET, thereby keeping the FET in a constant conductive state. If, however, the error signal is non-zero, then the integrator changes the level of the control signal to current control device 36a, thereby correspondingly varying the conductive state of the FET. The feedback produced via detector circuit 36b enables regulation, via the control signal, until the voltage across impedance circuit 32 again equals or substantially equals the reference voltage. At that time, integrator circuit 36f will again output a constant control signal. By virtue of this configuration, it is possible to maintain a substantially constant current during battery discharge, thereby resulting in relatively faster, more controlled, discharge.

This constant current may be maintained until the battery can no longer sustain it, after which a lower constant current may be set by changing the value of the reference voltage. This may continue until the battery is substantially discharged, or at least discharged to a point where it can be removed from the system relatively safely.

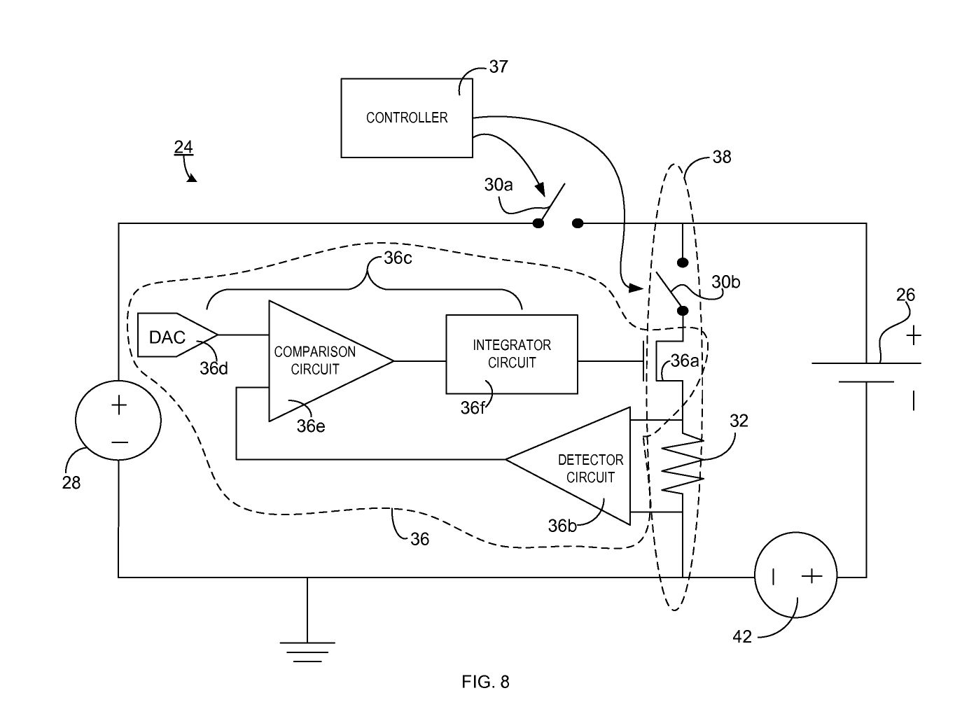

As indicated above, at some point during discharge, battery 26 may be unable to sustain the same constant current level that it supported at the beginning of discharge. Accordingly, as shown in FIG. 8, a voltage source 42 may be introduced to augment the current provided by battery 26. This configuration enables discharge at a constant current even after the battery alone cannot produce that current. That is, the voltage source allows the original constant current to be maintained, thereby maintaining the relatively rapid battery discharge rate through full (or close to full) depletion. To this end, the voltage source may be controllable by controller 37 to output voltage, based on a measured current through impedance circuit 32, to thereby bolster that current through impedance circuit 32 to maintain that current at constant level.

As was the case with respect to FIG. 4, discharge may occur until battery 26 is depleted. The battery may then be removed from the system relatively safely.

In the case of lithium-ion batteries, discharge typically occurs until the battery is fully depleted or depleted at least to a point where it can be removed from the system safely. However, as was the case above, controller 37 may be programmed to control switches 30a and 30b so that battery 26 is discharged a predefined amount (e.g., to a predefined voltage), whereafter controller 37 may control switches 30a and 30b to re-connect voltage source 28 to battery 26 and thereby proceed with charge and/or test. That is, switches 30a and 30b may be placed in the configuration of FIG. 7 for battery discharge until the voltage across battery 26 reaches a predefined level. Thereafter, switches 30a and 30b may be placed in the configuration of FIG. 6 for subsequent charge and/or test. In this example, circuitry (not shown) may be used to measure the voltage across battery 26, and to report that voltage back to controller 37.

In response to detection of a fault in a battery, controller 37 (in FIG. 4) or controller 21 (in FIG. 1) may discontinue testing/charging one or more batteries that are within a predefined area of the battery in which the fault was detected. This may be done, e.g., to protect other batteries and/or the test equipment, or so as to avoid exacerbating a dangerous situation involving the battery with the fault. Testing/charging may be stopped in FIG. 1 without discharging the corresponding battery by, e.g., opening switch 15a and leaving switch 15b open. Testing/charging may be stopped in FIG. 4 without discharging the corresponding battery by opening switch 30a and leaving switch 30b open.

An example of a system where it may be necessary to protect other batteries in the event of a fault is described in U.S. Provisional Application No. 61/359,597, entitled “TEST SYSTEM” (Attorney Docket No. 18523-100P01/2236-US). In such a system, batteries being tested are stored in totes. Robots move these totes into, and out of, slots in a rack, thereby interfacing the batteries in the totes to test channels. If a fault is detected in a battery in a tote, a controller may stop testing/charging one or more other batteries in the tote in the manner described herein (e.g., using, for each channel, circuitry identical to that of FIG. 1 or 4, or variants thereof). For example, all batteries adjacent to the defective battery may have testing/charging stopped; all batteries in a same row as the defective battery may have testing/charging stopped; all batteries in the tote containing the defective battery may have testing/charging stopped; and/or all batteries in a test rack containing the tote with the defective may have testing/charging stopped. Basically, any battery in the system may have its testing/charging stopped by the controller in response to detection of a fault in any other battery in the system.

Furthermore, in response to detection of a fault in a battery, controller 21 (in FIG. 1) or controller 37 (in FIG. 4) may instruct rapid discharge one or more batteries that are within a predefined area of the battery in which the fault was detected (e.g., by putting the appropriate switches in the configuration of FIG. 3 or FIG. 7). This may be done, e.g., in the event of fire or other hazard, or simply to protect other batteries, other features of the overall system, and the facility in which this is all housed. For example, all batteries adjacent to the defective battery may be discharged; all batteries in a same row as the defective battery may be discharged; all batteries in the tote containing the defective battery may be discharged; and/or all batteries in a test rack containing the tote with the defective may be discharged. Basically, any battery in the system may be discharged in response to detection of a fault in any other battery in the system.

In addition, in the event of a fault, the system controller (e.g., controller 21 or 37) may also, if necessary, activate fire extinguishing (e.g., CO₂) elements in the battery test system, particularly those fire extinguishing elements that are near to, and directed at, the battery with the fault.

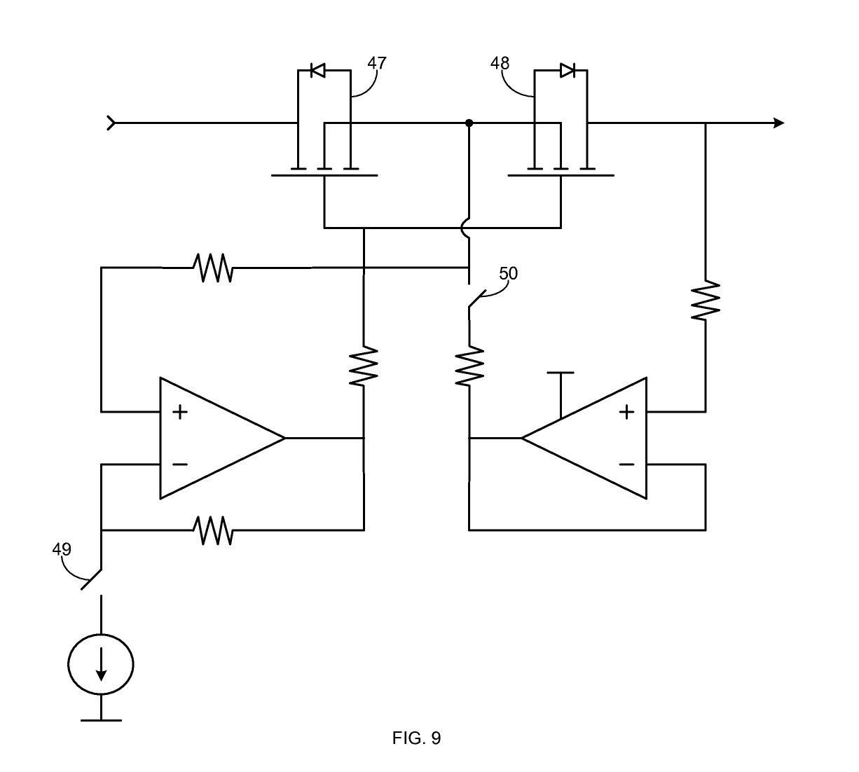

The circuitry of FIGS. 1 and 4 may contain leakage isolation circuitry to control an effect of transistor leakage on channel measurement accuracy. An example of leakage isolation circuitry that may be used for each switch 15a, 15b, 30a, 30b is shown in FIG. 9. For example, each switch 15a, 15b, 30a, 30b may be implemented using the circuitry shown in FIG. 9. This circuitry may be implemented using a pair of FETs 47 and 48. The circuitry is operated by driving the midpoint to the same voltage as the side of the switch intended to be low leakage. In this case, each switch 15a, 15b, 30a, 30b may be closed by closing switch 50 and opening switch 49 of FIG. 9, and each switch 15a, 15b, 30a, 30b may be opened by closing switch 49 and opening switch 50 of FIG. 9.

Any of the functionality described herein and its various modifications (hereinafter “the functions”) is not limited to the hardware and software described herein. All or part of the functions shown herein using circuitry can be implemented, at least in part, via a computer program product, e.g., a computer program tangibly embodied in an information carrier, such as one or more non-transitory machine-readable storage media, for execution by, or to control the operation of, one or more data processing apparatus, e.g., controller 21 and/or 37, a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

Components of different embodiments described herein may be combined to form other embodiments not specifically set forth above. Components may be left out of the circuitry shown in FIGS. 1 to 9 without adversely affecting their operation. Furthermore, various separate components may be combined into one or more individual components to perform the functions described herein.

An electrical connection may imply a direct physical connection or a connection that includes intervening components but that nevertheless allows electrical signals to flow between connected components. Any “connection” involving electrical circuitry mentioned or shown herein, unless stated otherwise, is an electrical connection and not necessarily a direct physical connection regardless of whether the word “electrical” is used to modify “connection” and regardless of whether intervening components are shown as part of the connection.

The features described in this patent application may be combined with any one or more of the features described in the following applications: U.S. Provisional Application No. 61/359,597, entitled “TEST SYSTEM” (Attorney Docket No. 18523-100P01/2236-US); U.S. patent application Ser. No. 12/825,941, entitled “ELECTRONIC DETECTION OF SIGNATURES” (Attorney Docket No. 18523-0119001/2234 US); U.S. patent application Ser. No. 12/826,083, entitled “REMOVING BAYS OF A TEST SYSTEM” (Attorney Docket No. 18523-0120001/2231-US); U.S. patent application Ser. No. 12/826,063, entitled “CALIBRATING A CHANNEL OF A TEST SYSTEM” (Attorney Docket No. 18523-0121001/2232-US); and U.S. patent application Ser. No. 12/825,998, entitled “ZERO INSERTION FORCE SCRUBBING CONTACT” (Attorney Docket No. 18523-0122001/2233-US). The contents of the following applications are incorporated herein by reference if set forth herein in full: U.S. Provisional Application No. 61/359,597, entitled “TEST SYSTEM” (Attorney Docket No. 18523-100P01/2236-US); U.S. patent application Ser. No. 12/825,941, entitled “ELECTRONIC DETECTION OF SIGNATURES” (Attorney Docket No. 18523-0119001/2234 US); U.S. patent application Ser. No. 12/826,083, entitled “REMOVING BAYS OF A TEST SYSTEM” (Attorney Docket No. 18523-0120001/2231-US); U.S. patent application Ser. No. 12/826,063, entitled “CALIBRATING A CHANNEL OF A TEST SYSTEM” (Attorney Docket No. 18523-0121001/2232-US); and U.S. patent application Ser. No. 12/825,998, entitled “ZERO INSERTION FORCE SCRUBBING CONTACT” (Attorney Docket No. 18523-0122001/2233-US).

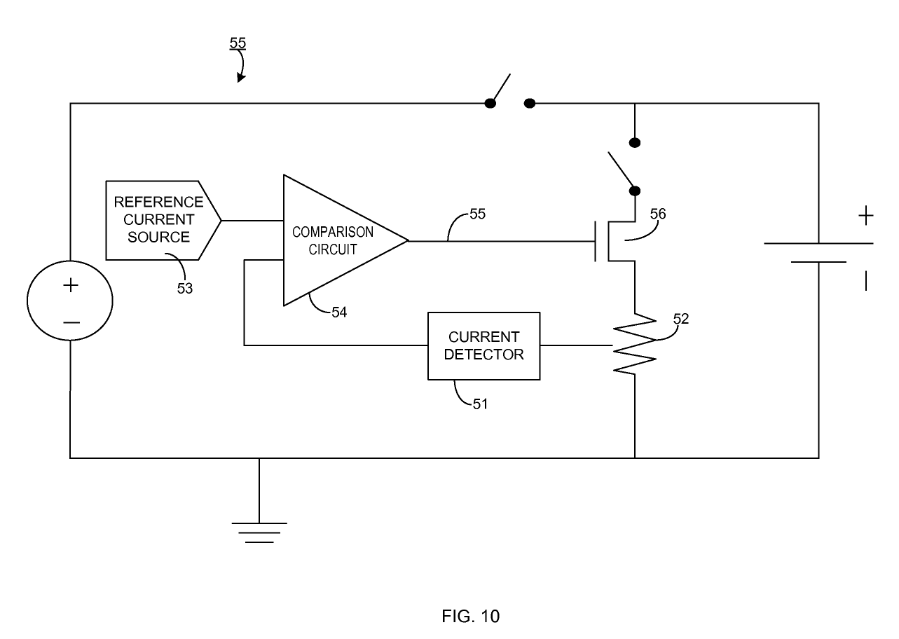

In other implementations, control circuitry 36 may be replaced by circuitry that directly senses the current through the impedance circuit, and that regulates the control signal to current control device in response to this sensed current. An example of such a circuit is shown in FIG. 10. An ammeter or other current detector 51 may be used to directly measure the current through impedance circuit 52. That measured current may be compared, by a comparison circuit 54 such as those described above, to a reference current output by reference current generator 53. The resulting output signal 55 may be used to control current control device 56 in a way that is similar to FIGS. 1 and 4. For example, if the current through impedance circuit 52 remains at a predefined level, a control signal 55 is generated to keep the current control device (e.g., a FET) in a constant conductive state. If, however, however, the current through impedance circuit 52 deviates from the predefined level, the control signal to current control device 56 may be varied, thereby correspondingly varying the conductive state of the FET. The feedback path shown in FIG. 10 regulates the current until it again reaches a steady state level.

The discharging circuitry described herein may be used in response to any fault, and is not limited to faults involving thermal abnormalities. Furthermore, the circuitry is not limited to discharging a battery in response to a detected fault, but instead may be used to discharge a battery under any appropriate condition.

The discharging circuitry described herein may be used with any type of battery or storage cell, and is not limited to use with lithium-ion batteries.

The discharging circuitry described herein is not limited to use with a battery test system or to the architecture shown (e.g., FIGS. 1 to 10). Rather, the circuitry can be used with any type of system that requires discharge of a storage cell.

Other embodiments not specifically described herein are also within the scope of the following claims.

What is claimed is:

1. A system comprising:
a channel over which to charge a battery;
control circuitry; and
a discharge circuit associated with the channel to discharge the battery, the discharge circuit being configured for discharging the battery at a current that exceeds an operational current through the channel;
wherein, in response to a fault in the battery, the control circuitry is configured to disconnect the battery from a signal path in the channel and to produce an electrical connection to enable discharge of the battery through the discharge circuit.

2. The system of claim 1, wherein the control circuitry comprises:
a first switch configured to connect/disconnect the battery to/from a test/charging path in the channel;
a second switch configured to connect/disconnect the battery to a discharge path; and
a controller to control the first switch and the second switch.

3. The system of claim 1, wherein the fault comprises thermal runaway in the battery.

4. The system of claim 1, wherein the control circuitry comprises:
regulator circuitry to regulate current through the battery during discharge so that current through the discharge circuit is substantially constant during at least a portion of the time that the battery is discharging.

5. The system of claim 1, wherein the control circuitry comprises a controller, the controller being configured to disconnect, from corresponding channels, batteries that are within a predefined area relative to the battery having the fault, thereby inhibiting further charging of the batteries.

6. The system of claim 1, wherein the control circuitry comprises a controller, the controller being configured to initiate discharge of batteries that are within a predefined area relative to the battery having the fault.

7. The system of claim 6, wherein the batteries within the predefined area comprise batteries that are directly adjacent to the battery having the fault.

8. A system comprising:
a discharge element to discharge a battery; and
control circuitry to control discharge of the battery in response to detection of a fault in the battery in order to maintain a substantially constant current through the discharge element during at least part of a period of time during which the battery discharges.

9. The system of claim 8, wherein the control circuitry comprises:
a current control device in a circuit path between the discharge element and the battery;
a detector to detect a voltage across the discharge element and thereby output a detected voltage; and
a regulator circuit to regulate a control signal to the current control device in accordance with the detected voltage.

10. The system of claim 9, wherein the regulator circuit comprises:
a voltage source to produce a reference voltage;
a comparison circuit to compare the reference voltage to the detected voltage and thereby output an error voltage; and
a controller to regulate the control signal based on the error voltage.

11. The system of claim 10, wherein the current control device comprises a field-effect transistor.

12. The system of claim 11, further comprising:
leakage isolation circuitry to control transistor leakage in the control circuitry.

13. The system of claim 11, wherein the detector comprises a first differential amplifier and wherein the comparison circuit comprises a second differential amplifier.

14. A system comprising:
a channel over which to charge a battery;
controlling means; and
discharging means associated with the channel for discharging the battery, the discharging means for discharging the battery at a current that exceeds an operational current through the channel;
wherein, in response to a fault in the battery, the controlling means disconnects the battery from the channel and produces an electrical connection to enable discharge of the battery through the discharge circuit.

15. A method of discharging a battery, comprising:
detecting a fault in a battery during test or formation of the battery; and
discharging the battery in response to the fault, the discharging being performed at a current that exceeds an operational current through a communication channel over which test or formation occurs.

16. The method of claim 15, wherein test or formation comprises sending signals to the battery over a channel, and wherein the method further comprises:
disconnecting the battery from a signal path in the channel in response to the fault; and
establishing an electrical connection to enable discharge of the battery through a discharge circuit.

17. The method of claim 15, wherein discharging occurs while maintaining a substantially constant current through the battery.

18. The method of claim 17, further comprising controlling a current control device to maintain the substantially constant current.

19. The method of claim 15, wherein discharging occurs through an impedance circuit that is electrically connected in a current path with the battery in response to detecting the fault.
